(19) United States
(12) Patent Application Publication
(10) Pub. No.: US 2008/0285768 A1
(43) Pub. Date: Nov. 20, 2008

(54) Method and System for Modifying and Audio Signal, and Filter System for Modifying an Electrical Signal

(76) Inventors: Soren M. Larsen, Copenhagen (DK); Lars Hog-Iversen, Hvidovre (DK)

Correspondence Address: GIFFORD, KRASS, SPRINKLE,ANDERSON & CITKOWSKI, P.C, PO BOX 7021, TROY, MI, 48007-7021, US

(21) Appl. No.: 11/911,837

(22) PCT Filed: Apr. 18, 2006
(86) PCT No.: PCT/DK2006/000207

§ 371 Date: Jun. 9, 2008

(30) Foreign Application Priority Data
Apr. 18, 2005 (DK) PA2005 00560

(51) Int. Cl. H04R 3/02

(52) U.S. Cl. 381/73.1

(57) ABSTRACT

There is provided a filter system for modifying an electrical signal. The filter system has an input for receiving an electrical signal to be modified, a subtraction circuit for delivering a modified output signal, a direct signal part between the input and the subtraction circuit, and a modifying signal part between the input and the subtraction circuit. The modifying signal part comprises one or more inverse comb filter signal paths, where each inverse comb filter signal path has circuitry for performing an inverse comb filter function. The subtraction circuit is designed for performing a subtraction of the signals supplied via the direct signal part and the modifying signal part to thereby obtain the modified output signal. The hereby provided filter system may be used as an inverse comb filter system for modifying an audio signal in an audio system. Thus, there is also provided an audio system having an audio signal source for outputting an electrical signal representing an acoustic audio signal, and a sound source for reproducing an acoustic audio signal, said sound source having an electrical signal input and being operative to generate an acoustic audio output in response to a signal supplied to the electrical signal input. The audio system further has one or more of the inverse e comb filter systems arranged between the audio signal source and the signal input of the sound source for delivering a modified signal to the electrical signal input of the sound source. The signal supplied to the subtraction circuit by the modifying signal part may be filtered by use of the one or more inverse comb filter functions.

### FIELD OF THE INVENTION

The present invention relates generally to a method and a system for modifying an audio signal, and more particularly to a method and a system wherein a modified audio signal is produced by use of a number of inverse comb filters. The modified audio signal may be subtracted from a non-modified audio signal and the resultant signal may be used as input to a sound source for generating a modified acoustic audio signal. The inverse comb filters may be designed so as to suppress the effects of standing waves produced in a room surrounding the sound source as well as standing waves in mechanical devices featuring one or more transducers, such as loudspeakers. The present invention further relates to a filter system for modifying an electrical signal.

### BACKGROUND OF THE INVENTION

The signal path from an original sound source to the human ear may in general include a pickup receiving the sound and converting it to an electrical signal; signal transmission channels; signal processing means (e.g. filtering, tone control or noise reduction); signal transmission, or alternatively recording on to a record carrier; signal reception or alternatively replaying from the record carrier; a further transmission link; and reconverting into an audio signal via a loudspeaker. From the loudspeaker, the final stage in the path is transmission through an acoustic environment (typically a room) to the human ear.

Associated with each stage of the signal path is a transfer characteristic, and at various stages in the path attempts may be made to filter the signal to compensate the effects of these transfer characteristics. Compensation generally takes place at a stage in the signal path subsequent to the stages to be compensated. For example, in the case of a sound recording, the signal will be filtered at mixing and cutting stages so as to compensate, if necessary, for the recording environment and equipment.

At the reproduction stage, it is common to provide a so-called “graphic equalizer” comprising a plurality of band pass filters each with its own gain control, through which the signal is passed, to allow a listener to re-equalize the reproduced sound signal. The graphic equalizer is generally positioned between the record carrier reader (e.g. compact disc player) and the power amplifier driving the loudspeaker.

Since such equalizers are adjusted manually, their setting is a matter for the personal taste of the listener, but they can be used to compensate for large-scale irregularities in the amplitude response of the loudspeaker and of the acoustic environment in which the loudspeaker is positioned.

In fact, with modern high fidelity audio equipment, the major variations in sound reproduction quality are due to the transfer functions of the loudspeaker and of the acoustic environment in which the loudspeaker is positioned.

The loudspeaker often comprises several separate transducers responsive to different frequency ranges, the loudspeaker input signal being split into the ranges by a cross-over network (which may be an analogue filter), and the transducers being mounted in a cabinet. The transfer function of the loudspeaker will thus depend upon the electrical characteristics of the crossover network and of the transducers; on the relevant position of the transducers; on the interior cavity of the cabinet (which is also similar in behaviour as the external acoustic environment, but with shorter internal distances and hereby higher problem frequencies) and on the mechanical resonances of the cabinet. The transfer function of the acoustic environment may be visualised by considering that the signal passes through multiple paths between the loudspeaker and the human ear. There is the direct path through the air between the two as well as reflected paths from the (at least) four walls, ceiling and floor. This leads to constructive and destructive acoustic interference and to standing wave patterns of considerable complexity within the room, so that the paths from the loudspeaker to different points in the room will have different transfer characteristics—where the room exhibits pronounced resonances, these transfer characteristics can be extremely different, with complete cancellation at some frequencies, the frequencies differing between different points—and at the same time being amplified at some frequencies, the frequencies differing between different points. These amplified resonances may be audible as colorations of the reproduced sound, and as relatively long reverberations.

It would in principle be desirable to provide a compensating filter and means for deriving the parameters of the filter such that a given sound source would be reproduced substantially identically through any loudspeaker and/or acoustic environment, so as to free the listener from the need to carefully select certain loudspeakers, and pay attention to their position within a room and to the acoustic properties of the room.

One example of a proposal to achieve this is described in U.S. Pat. No. 4,458,362, in which it is proposed to provide a finite impulse response digital filter (implemented by a microcomputer and a random access memory) in the signal path preceding the loudspeaker. The coefficients of the filter are derived in an initial phase, in which a listener positions himself at his desired listening point within a room and instructs the microprocessor to generate a test signal which is propagated via the loudspeaker through the room to the listener position and picked up by a microphone carried by the listener. From the test signal and signal picked up by the microphone, the impulse response of the intervening portions of the signal path (e.g. the loudspeaker and the acoustic path through the room to that listener position) is derived and coefficients of an FIR filter approximating the inverse transfer characteristic to that of the signal path are calculated and used in subsequent filtering.

Suggested prior art solutions to the problem of providing compensation for room acoustic problems may require very large FIR filters, followed by a high demand of computing power. Thus, there is a need for a solution built on principles having a lesser demand of computing power. Such a solution may be provided by the present invention.

### SUMMARY OF THE INVENTION

According to a first aspect of the present invention there is provided an audio system comprising:

an audio signal source for outputting an electrical signal representing an acoustic audio signal,
a sound source for reproducing an acoustic audio signal, said sound source having an electrical signal input and being operative to generate an acoustic audio output in response to a signal supplied to the electrical signal input, and
one or more inverse comb filter systems arranged between the audio signal source and the signal input of the sound source for delivering a modified signal to the electrical signal input of the sound source, wherein each inverse comb filter system comprises a subtraction circuit for delivering a modified inverse comb filter system output signal, a direct signal part or path between the input of the inverse comb filter system and the subtraction circuit, and
a modifying signal part or path between the input of the inverse comb filter system and the subtraction circuit, said modifying signal part comprising one or more inverse comb filter signal paths, each said inverse comb filter signal path having circuitry for performing an inverse comb filter function, and said subtraction circuit being designed for performing a subtraction of the signals supplied via the direct signal part and the modifying signal part to thereby obtain the modified inverse comb filter system output signal.

Preferably, the signal supplied to the subtraction circuit by the modifying signal part may have been filtered by use of the one or more inverse comb filter functions.

It is preferred that the inverse comb filter functions are performed using digital filter means or circuitry. It is also preferred that the signals supplied to the subtraction circuit are on digital form.

It is within an embodiment of the invention that the audio system of the invention comprises at least a first and a second of said inverse comb filter systems arranged in series. Hereby, the modified filter output signal of the first inverse comb filter system may provide an input signal to the direct signal part and the modifying signal part of the second inverse comb filter system.

It is also within an embodiment of the invention that the audio system of the invention comprises at least a first, a second and a third of said inverse comb filter systems arranged in series. Hereby, the modified filter output signal of the first inverse comb filter system may provide an input signal to the direct signal part and the modifying signal part of the second inverse comb filter system, and the modified filter output signal of the second inverse comb filter system may provide an input signal to the direct signal part and the modifying signal part of the third inverse comb filter system. The audio system of the invention may also comprise at least four, five or six of said inverse comb filter systems arranged in series.

According to an embodiment of the invention each modifying signal part of said inverse comb filter systems may comprise one and only one inverse comb filter signal path.

According to another embodiment of the invention the audio system may comprise one inverse comb filter system with the modifying signal part comprising at least two or three inverse comb filter signal paths in parallel.

The circuitry for performing an inverse comb filter function may comprise at least one feed-back circuit architecture, which may be an IIR circuit architecture.

It is preferred that the inverse comb filter function of an inverse comb filter signal path is selected so as compensate for or modifying the effects of standing waves corresponding to a characteristic longitudinal dimension of the surroundings of the sound source and/or corresponding to a characteristic longitudinal dimension of the internal acoustic environment of a device featuring at least one transducer/loudspeaker. Standing waves in the surroundings of the sound source may typically be most significant below the 300 Hz-500 Hz ranges, whereas the effect of standing waves of the internal acoustic environment of a device featuring at least one transducer/loudspeaker may be present at any audible frequency, which may be up to 20.000 Hz.

Thus, it is within an embodiment of the invention that a first inverse comb filter signal path comprises circuitry for performing a first inverse comb filter function, said first inverse comb filter function being selected so as compensate for or modify the effects of standing waves corresponding to a first characteristic longitudinal dimension of the surroundings of the sound source. Furthermore, a second inverse comb filter signal path may comprise circuitry for performing a second inverse comb filter function, said second inverse comb filter function being selected so as compensate for or modify the effects of standing waves corresponding to a second characteristic longitudinal dimension of the surroundings of the sound source. It is also within an embodiment of the invention that a third (or any number of further) inverse comb filter signal path comprises circuitry for performing a third (or any number of further) inverse comb filter function, said hereto corresponding inverse comb filter function being selected so as compensate for or modify the effects of standing waves corresponding to a third (or any number of further) characteristic longitudinal dimension of the surroundings of the sound source.

It is preferred that the modifying signal part of each of said one or more inverse comb filter systems has delay circuitry for providing a time delay to each or at least part of said one or more inverse comb filter signal paths. The time delay may be provided in the signal path before the inverse comb filter function. It is preferred that the time delay of an inverse comb filter signal path is selected so as compensate for or modify the effects of standing waves corresponding to a characteristic longitudinal dimension of the surroundings of the sound source. The time delay and the inverse comb filter function of an inverse comb filter signal path may be selected so as to compensate for or modify the effects of standing waves corresponding to the same characteristic longitudinal dimension of the surroundings of the sound source. Here, the time delay and the inverse comb filter function of the inverse comb filter signal path may be selected so that

the frequency response of the output signal of the inverse comb filter signal path has magnitude peaks at different frequencies than the magnitude notches of the frequency response of the standing waves corresponding to the selected characteristic longitudinal dimension of the surroundings of the sound source. Preferably, the time delay and the inverse comb filter function of the inverse comb filter signal path are selected so that
the frequency response of the output signal of the inverse comb filter signal path has magnitude peaks at substantially the same frequencies as the magnitude peaks of the frequency response of the standing waves corresponding to the selected characteristic longitudinal dimension of the surroundings of the sound source. The time delay can be from 0 mSec and upwards.

It is within an embodiment of the invention that an inverse comb filter signal path further has circuitry for performing an amplitude shaping of the output of the inverse comb filter circuitry of said inverse comb filter signal path, thereby providing an amplitude shaped output of the inverse comb filter signal path. Here, the amplitude shaping circuitry or means may comprise IIR filtering circuitry.

It is also within an embodiment of the invention that the modifying signal path comprises a FIR filter signal path arranged in parallel with one or more inverse comb filter signal paths.

The present invention may also cover an embodiment wherein the direct signal path has delay circuitry for providing a time delay to the signal supplied to the subtraction circuit.

It is preferred that the outputs of inverse comb filter signal paths being arranged in parallel are summed to provide a summed inverse comb filter signal being used for the output of the modifying signal part to be used as input for the subtraction circuit. This summation may preferably be used when the inverse comb filter signal paths are not having significant influence upon each other, meaning that the frequencies of each filter section are wide apart e.g. 20 Hz for the first path, 200 Hz for the second path and 2.000 Hz for the third path.

In case that the frequencies are close, e.g. 29 Hz, 43 Hz and 69 Hz, corresponding to a room of approx. 6 m×4 m×2.5 m, then it is preferred to have inverse comb filter systems arranged in series.

It is within an embodiment of the present invention that the output signal of the subtraction circuit providing the signal to the signal input of the sound source is fed through equalising circuitry before being directed to the signal input of the sound source. This may be done to match the spectrum of the filter paths to counteract the acoustic problems in the surroundings of the sound source, or the internal cavity of a device featuring a transducer/loudspeaker.

According to the first aspect of the present invention there is also provided a method of modifying an audio signal using an audio system, said audio system comprising: an audio signal source for outputting an electrical signal representing an acoustic audio signal; a sound source for reproducing an acoustic audio signal, said sound source having an electrical signal input and being operative to generate an acoustic audio output in response to a signal supplied to the electrical signal input; and one or more inverse comb filter systems arranged between the audio signal source and the signal input of the sound source for delivering a modified signal to the electrical signal input of the sound source; wherein the method comprises:

generating for each of the inverse comb filter systems a direct audio signal based at least partly on the output of the audio signal source,
generating for each of the inverse comb filter systems a modified audio signal based at least partly on the output of the audio signal source, and
for each of the inverse comb filter systems performing a subtraction of the corresponding generated direct audio signal and the corresponding generated modified audio signal to thereby obtain a corresponding modified inverse comb filter system output,
wherein the generation of the modified audio signal(s) is/are accomplished by means of one or more corresponding inverse comb filter functions.

Also for the method of the invention it is preferred that the inverse comb filter functions are performed using digital filter means or circuitry. It is also preferred that the signals supplied to the subtraction circuit are on digital form.

Also the method of the invention covers an embodiment wherein the audio system has at least a first and a second of said inverse comb filter systems arranged in series.

The method of the invention also covers an embodiment wherein the audio system has at least a first and a second of said inverse comb filter systems arranged in series. The audio system may also have at least three, four or five of said inverse comb filter systems arranged in series. It is within a preferred embodiment of the invention that the generation of each of the modified audio signals is accomplished by means of one and only one inverse comb filter function.

It is within an embodiment of the method of the invention that several inverse comb filter functions are performed in parallel to thereby generate a modified audio signal. Here, the generation of a modified audio signal may be accomplished by means of at least two or three inverse comb filter functions being performed in parallel.

According to an embodiment of the method of the invention, an inverse comb filter function may be performed by a circuitry comprising at least one feed-back circuit architecture, which may be an IIR circuit architecture.

It is preferred that an inverse comb filter function being used for the generation of the modified audio signal is selected so as compensate for or modifying the effects of standing waves corresponding to a characteristic longitudinal dimension of the surroundings of the sound source.

Thus, it is within an embodiment of the method of the invention that a first inverse comb function is selected so as compensate for or modify the effects of standing waves corresponding to a first characteristic longitudinal dimension of the surroundings of the sound source. Furthermore, a second inverse comb filter function may be selected so as compensate for or modify the effects of standing waves corresponding to a second characteristic longitudinal dimension of the surroundings of the sound source. It is also within an embodiment of the method of the invention that a third inverse comb filter function is selected so as compensate for or modify the effects of standing waves corresponding to a third characteristic longitudinal dimension of the surroundings of the sound source.

It is preferred that the generation of the modified audio signal includes providing a time delay to each or at least part of the inverse comb filter functions. The time delay may be provided in a signal path before the inverse comb filter function. It is preferred that the time delay of an inverse comb filter function is selected so as compensate for or modify the effects of standing waves corresponding to a characteristic longitudinal dimension of the surroundings of the sound source. Here, for a corresponding set of time delay and inverse comb filter function, the time delay and the inverse comb filter function may be selected so as to compensate for or modify the effects of standing waves corresponding to the same selected characteristic longitudinal dimension of the surroundings of the sound source. It is preferred that, for the corresponding set of time delay and inverse comb filter function, the time delay and the inverse comb filter function are selected so that the frequency response of the output signal of the inverse comb filter function has magnitude peaks at different frequencies than the magnitude notches of the frequency response of the standing waves corresponding to the selected characteristic longitudinal dimension of the surroundings of the sound source. Preferably, for the corresponding set of time delay and inverse comb filter function, the time delay and the inverse comb filter function are selected so that the frequency response of the output signal of the inverse comb filter function has magnitude peaks at substantially the same frequencies as the magnitude peaks of the frequency response of the standing waves corresponding to the selected characteristic longitudinal dimension of the surroundings of the sound source.

It is within an embodiment of the method of the invention that the generation of the modified audio signal further includes performing an amplitude shaping of the output of each or at least part of the inverse comb filter functions.

It is also within an embodiment of the method of the invention that the generation of the modified audio signal is further accomplished by a FIR filtering function being performed in parallel with the one or more inverse comb filter functions.

The method of the present invention also covers an embodiment wherein the direct audio signal is delayed in relation to the output of the audio signal source.

It is preferred that the outputs of the inverse comb filter functions or the amplitude shaped outputs of the inverse comb filter functions are summed to provide a summed inverse comb filter signal being used for the output of the modified audio signal to be used for the subtraction step.

It is also within an embodiment of the method of the invention that the resulting signal of the subtraction is fed through equalising circuitry to thereby obtain said input signal to the signal input of the sound source.

According to a second aspect of the present invention there is provided a filter system for modifying an electrical signal, said filter system comprising:

an input for receiving an electrical signal to be modified,
a subtraction circuit for delivering a modified output signal,
a direct signal part between the input and the subtraction circuit, and
a modifying signal part between the input and the subtraction circuit, said modifying signal part comprising one or more inverse comb filter signal paths, each said inverse comb filter signal path having circuitry for performing an inverse comb filter function, and said subtraction circuit being designed for performing a subtraction of the signals supplied via the direct signal part and the modifying signal part to thereby obtain the modified output signal.

For the filter system of the second aspect of the invention it is preferred that the signal supplied to the subtraction circuit by the modifying signal part has been filtered by use of the one or more inverse comb filter functions.

Also for the filter system for the second aspect of the invention it is preferred that the inverse comb filter functions are performed using digital filter means or circuitry. It is also preferred that the signals supplied to the subtraction circuit are on digital form.

According to an embodiment of the second aspect of the invention the modifying signal part may comprise one and only one inverse comb filter signal path. However, it is also within an embodiment of the second aspect of the invention that the modifying signal part comprises at least two or three inverse comb filter signal paths in parallel.

Also for the filter system of the second aspect of the invention, it is preferred that the circuitry for performing an inverse comb filter function comprises at least one feed-back circuit architecture, which may be an IIR circuit architecture.

For the filter system of the second aspect of the invention it is preferred that the modifying signal part has delay circuitry for providing a time delay to each or at least part of the inverse comb filter signal paths. The time delay may be provided in the signal path before the inverse comb filter function circuitry.

It is also within an embodiment of the filter system of the second aspect of the invention that an inverse comb filter signal path further has circuitry or means for performing an amplitude shaping of the output of the inverse comb filter circuitry or means of said inverse comb filter signal path, thereby providing an amplitude shaped output of the inverse comb filter signal path. Here, the amplitude shaping circuitry or means may comprise IIR filtering circuitry.

According to an embodiment of the filter system of the second aspect of the invention, the modifying signal path may comprise a FIR filter signal path arranged in parallel with one or more inverse comb filter signal paths.

It is within an embodiment of the filter system of the second aspect of the invention that the direct signal path has delay circuitry for providing a time delay to the signal supplied to the subtraction circuit.

Also for the filter system of the second aspect of the invention it is preferred that the outputs of parallel arranged inverse comb filter signal paths are summed to provide a summed inverse comb filter signal being used for the output of the modifying signal part to be used as input for the subtraction circuit.

Other objects, features and advantages of the present invention will be more readily apparent from the detailed description of the preferred embodiments set forth below, taken in conjunction with the accompanying drawings.

### BRIEF DESCRIPTION OF THE DRAWINGS

FIG. 1a is a functional block diagram illustrating an embodiment of a digital room compensation system according to the principles of the present invention with parallel configuration of inverse comb filters and an additional FIR filter in the parallel structure,

FIG. 1b is a functional block diagram illustrating an embodiment of a digital room compensation system according to the principles of the present invention with same basic configuration as in FIG. 1a, but without the additional FIR filter as this may be made redundant in some applications,

FIG. 1c is a functional block diagram illustrating an embodiment of a digital room compensation system according to the principles of the present invention with cascaded inverse comb filters,

FIG. 2 is a drawing illustrating the effects of difference in time delays from two separated loudspeakers to a listening position,

FIG. 3a is a drawing illustrating the effects of difference in sound travel distances between different units of a loudspeaker,

FIG. 3b is a diagram illustrating a FIR filter system used as a solution to the problem illustrated in FIG. 3a,

FIG. 4 is a drawing illustrating the effects of difference in time delays for audio signals travelling along different routes from a loudspeaker to a listening position,

FIG. 5a is a block diagram showing a RAM based delay circuit, which according to an embodiment of the present invention, may be used to address the time delay problems illustrated in FIG. 4,

FIG. 5b is an alternative block diagram showing a RAM based delay circuit, which according to an embodiment of the present invention, may be used to address the time delay problems illustrated in FIG. 4,

FIG. 6a is a drawing illustrating a comb frequency response of standing waves of an audio signal in a room with lossless reflection,

FIG. 6b is a drawing illustrating the frequency response of an inverse comb function,

FIG. 6c is a drawing illustrating a comb function and an inverse comb function having maximum amplitudes at the same frequencies,

FIG. 6d is a diagram illustrating a filter construction, which according to an embodiment of the principles of the present invention may be used in order to realize an inverse comb filter function,

FIG. 7a is a drawing illustrating amplitude attenuation for higher harmonics of a room resonance frequency response,

FIG. 7b is a drawing illustrating amplitude attenuation for higher harmonics of an inverse comb function according to an embodiment of the principles of the present invention,

FIG. 7c is a diagram illustrating an IIR BiQuad filter system, which according to an embodiment of the principles of the present invention, may be used in order to realize amplitude attenuation for higher harmonics of an inverse comb function, and

FIG. 8 is a drawing illustrating subtraction of an inverse comb function from a room resonance comb function according to an embodiment of the principles of the present invention.

### DETAILED DESCRIPTION OF THE INVENTION

Room acoustics problems like standing waves and resonances may be eliminated and thereby increase the audible performance of a system using loudspeakers.

However, this should ideally be done without introducing new problems. Problems of many prior art solutions are that the precision is insufficient, whereas a system using the principles of the present invention may obtain a very high precision without using very large computer resources to obtain the target. A 24 bit DVD-based system would require up to 119 MIPS per channel to perform the same degree of room compensation, which according to the principles of the present invention may be obtained by less than 18 MIPS. Furthermore, following the principles of the present invention the risk of introducing distortion to the source signal may be lowered significantly.

As an example, a prototype of a system for modifying an audio signal according to the principles of the present invention, is capable of modifying e.g. an f=69 Hz room resonance by only influencing a 2 Hz bandwidth. A 69 Hz room resonance may occur between ceiling and floor, when the distance between these are 2.5 meters as f=W(2*L), where V is the velocity of sound (App. 345 m/s) and L is the distance between the surfaces, where sound can bounce forth and back creating standing waves. A typical living room with the following dimensions, 6 m×4 m×2.5 m, may have room resonances at approx. 29 Hz (and harmonics thereof), 43 Hz (and harmonics thereof) and 69 Hz (and harmonics thereof).

The room resonances can be identified by traditional measurements and FFT-based operations. This is commonly described in basic acoustics engineering. A simple and effective method to identify the room resonances is to stimulate the combined system comprising of the loudspeakers and the room with a test signal, and then derive information about peaks and dips as well as RT60 (decay time to −60 dB of reverberation). Room resonances have long RT60 and can most often be found as peaks and dips in the frequency response of the combined system. Furthermore room resonances may have harmonics that may also be identified by the measurements. Thus, when a measurement and analysis shows a frequency where a peak is present, that is long RT60 occurs at the frequency, and harmonics are also identified, then it is fair to conclude that a fundamental room resonance has been found. It must be noted that a room may have many fundamental resonances, and in such case the application of digital room compensation may be done to the most dominating resonances. It may be acceptable to leave some minor resonances uncompensated, if desired.

When using prior art principles, it may require very large FIR-filters of several thousands of taps (or significant decimation) to obtain sufficient precision (less than 2 Hz as minimum) to target the resonance problems without introducing new problems in the audio system performance. By using the principles of the present invention, it may take only one tap to remove harmonics of frequencies having room resonance problems. Compared to traditional FIR filter approaches, systems using the principles of the present invention may have significantly improved frequency precision, with variations equal to the sampling frequency. The precision of a FIR filter is determined by the number of used taps, and a higher number of taps is required when higher precision is demanded. To obtain a high performance using prior art FIR-filter techniques, significant decimation and a very high number of taps (equal to hundreds of thousands taps) is required, whereas when using the principles of the present invention, precisions of below 0.01 Hz at only one tap computing power may be obtained.

Following prior art principles, decimation of the FIR filter reduces the required number of taps, but the decimation also reduces the source signal bit resolution to lower sampling frequency. Hereby, such prior art principles may be destructive to the original source signal. Such destruction to the original source signal may be avoided by use of the principles of the present invention.

Also compared to systems using traditional IIR filters, then systems using the principles of the present invention may be far more precise in modifying the frequencies having room resonance problems, as the precision, which may be below 0.01 Hz, may be determined by simple delays and only a relatively small computing power may be required. Traditional IIR filters may have an inherent lack of precision at low frequencies and it may be impossible to design an IIR filter with the required precision of less than 2 Hz variations. Compared to traditional IIR filters, filters using the principles of the pre-sent invention may be almost on par in regard to low computing requirements, but with the significant difference that the filters according to the present invention may achieve the required precision, whereas this may be impossible with traditional IIR filters.

Another general problem with traditional IIR filters and FIR filters is that the relative precision of traditional IIR and FIR filters increases proportionally as function of the frequency. This is not required in audio applications, as the human ear perceives sound as a logarithmic function of frequency. The human ear has a basic resolution of approx. ⅙ of an octave meaning that high precision at high frequencies may not have any positive effect upon the audible experience. It can be said that traditional IIR filters and FIR filters have inherent high precision in the wrong frequency range to be used for audio applications. Filters using the principles of the present invention may have a decreasing precision with higher frequency and are thus much more similar to the human ear performance and requirements. For FIR filters in particular, it must be noted that almost all the computing power is used at high frequencies, e.g. the room compensation system suggested in U.S. Pat. No. 4,458,362 may use approx. 97% of the computing power at frequencies not related significantly to room acoustics problems. This also makes the FIR filter inefficient to target room acoustic problems in regard to computing power.

Unlike other prior art solutions, systems following the principles of the present invention may be fully scalable and may be scaled with regard to the modifying of room acoustic problems. FIR filters cannot be scaled (downwards), as all FIR filters require a minimum number of taps (often minimum 128 taps, which is furthermore completely insufficient for any room compensation application) to be able to perform any filter function with acceptable precision.

By following the principles of the present invention, both time domain and frequency domain optimisation of an audio system may be obtained, but with significantly lower computing power requirement when compared to prior art systems.

Yet another very important benefit of a system following the principles of the present invention is that decimation may not be required. Decimation may be required in prior art solutions in order to obtain sufficient precision when targeting frequencies having room resonance problems. A system according to principles of the present invention may have a frequency resolution below 0.01 Hz at 20 Hz in DVD applications without using any decimation, while the best prior art implementations may have a resolution around 1-2 Hz when decimation is used. Decimation may be destructive to the original source signal and should thus be avoided. However, if desired, decimation can also be applied to a system following the principles of the present invention.

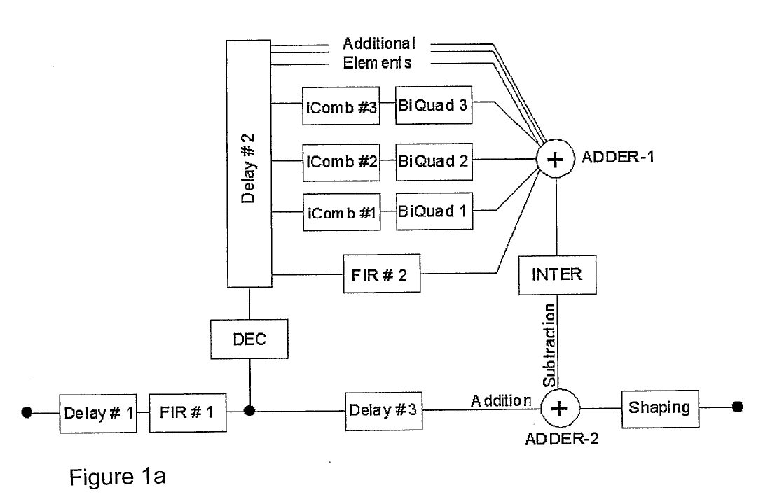

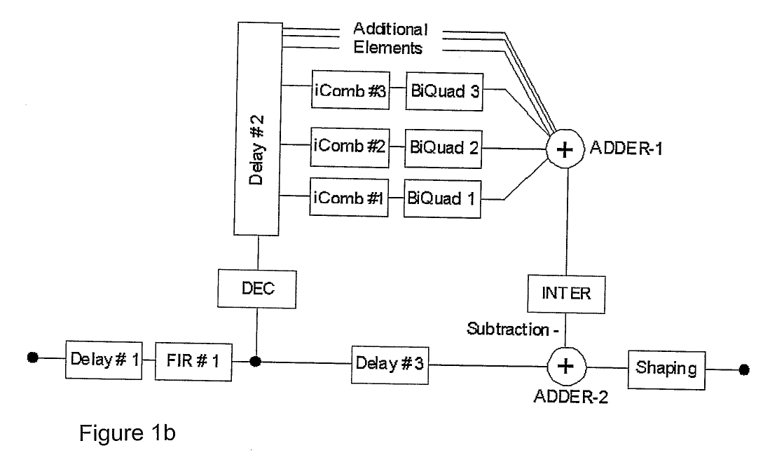

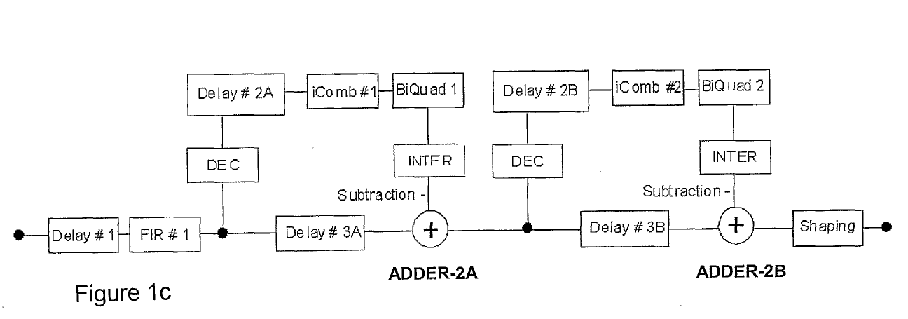

FIG. 1a, FIG. 1b and FIG. 1c are functional block diagrams illustrating audio systems using embodiments of a digital room compensation system according to the principles of the present invention.

The system of FIG. 1a has an input signal path with a delay block, Delay#1, a filter block, FIR#1, and an inverse comb filter system. The inverse comb filter system comprises a direct signal path or part with a delay block (optional), Delay#3, a modifying signal path or part parallel to the direct signal part or path, and a subtraction block, ADDER-2. The modifying signal part or path has a decimation block (optional), DEC, a delay block, Delay#2, a number of parallel inverse comb filter signal paths, each inverse comb filter signal path having an inverse comb filter block, iComb#n, and a corresponding filter block, BiQuad n, the outputs of the parallel arranged BiQuad filter blocks being fed to an adder, ADDER-1, the output of the adder, ADDER-1, being fed via an interpolation block (optional together with the decimation block), INTER, to the subtraction block, ADDER-2, where the output signal of the modifying signal part or path is subtracted from the output signal of the direct signal part or path. The output of the subtraction block, ADDER-2, is fed to an output signal path having an equaliser block, Shaping. The modifying signal part or path may further (optional) have a filter block, FIR#2, arranged in parallel with the inverse comb filter signal paths. The embodiment of the invention illustrated in FIG. 1a may be used when the inverse comb filters are not closely spaced (e.g. 20 Hz for the first inverse comb filter path, 200 Hz for the second inverse comb filter path and 2.000 Hz for the third inverse comb filter path). Furthermore, the embodiment in FIG. 1a may be used with a minimum number of taps for FIR#1, or even without any FIR#1.

The system of FIG. 1b has an input signal path with a delay block, Delay#1, a filter block, FIR#L, and an inverse comb filter system. The inverse comb filter system comprises a direct signal part or path with a delay block (optional), Delay#3, a modifying signal part or path parallel to the direct signal part or path, and a subtraction block, ADDER-2. The modifying signal part or path has a decimation block (optional), DEC, a delay block, Delay#2, a number of parallel inverse comb filter signal paths, each inverse comb filter signal paths having an inverse comb filter block, iComb#n, and a corresponding filter block, BiQuad n, the outputs of the parallel arranged BiQuad filter blocks being fed to an adder, ADDER-1, the output of the adder, ADDER-1, being fed via an interpolation block (optional together with the decimation block), INTER, to the subtraction block, ADDER-2, where the output signal of the modifying signal part or path is subtracted from the output signal of the direct signal part or path. The output of the subtraction block, ADDER-2, is fed to an output signal path having an equaliser block, Shaping. When comparing the system of FIG. 1b with the system of FIG. 1a, the filter block FIR#2, which is present in the system of FIG. 1a, has been removed as the precision of the system of FIG. 1b may be sufficient for many applications without adding the computing resources of FIR#2.

The system of FIG. 1c has an input signal path with a delay block, Delay#1, and a filter block, FIR#1, and two serially arranged inverse comb filter systems. The first inverse comb filter system has a direct signal part or path with a delay block (optional), Delay#3A, a modifying signal part or path parallel to the direct signal part or path, and a subtraction block, ADDER-2A. The modifying signal part or path of the first inverse comb filter system has a decimation block (optional), DEC, a delay block, Delay#2A, and an inverse comb filter signal path with an inverse comb filter block, iComb#1, and a corresponding filter block, BiQuad 1. The output of the BiQuad 1 filter is fed via an interpolation block (optional together with the decimation block), INTER, to the subtraction block, ADDER-2A, where the output signal of the modifying signal part or path is subtracted from the output signal of the direct signal part or path. The second inverse comb filter system has a direct signal part or path with a delay block (optional), Delay#3B, a modifying signal part or path parallel to the direct signal part or path, and a subtraction block, ADDER-2B. The modifying signal part or path of the second inverse comb filter system has a decimation block (optional), DEC, a delay block, Delay#2B, and an inverse comb filter signal path with an inverse comb filter block, iComb#2, and a corresponding filter block, BiQuad 2. The output of the BiQuad 2 filter is fed via an interpolation block (optional together with the decimation block), INTER, to the subtraction block, ADDER-2B, where the output signal of the modifying signal part or path is subtracted from the output signal of the direct signal part or path. The output from subtraction block, ADDER-2A, of the first inverse comb filter system is being used as input to the second inverse comb filter system. The output of the subtraction block, ADDER2B, of the second inverse comb filter system is fed to an output signal path having an equaliser block, Shaping.

The function of the system of FIG. 1c corresponds to the function of the systems of FIG. 1a and FIG. 1b, but the advantage of the system of FIG. 1c is that this topology is easier to implement, specially when the spacing between each cascaded parallel inverse comb filter block is close—e.g. 29 Hz, 43 Hz and 69 Hz in a configuration with three cascaded inverse filter blocks. Furthermore, the embodiment in FIG. 1c may be used with a minimum number of taps for FIR#1, or even without FIR#1. In general it has been found that DEC, Delay#3 and INTER are not required in most applications, but if desired they may be implemented if further reduction of computing power requirements are desired.

The functional blocks of the diagram of FIG. 1a, FIG. 1b and FIG. 1c will be described in the following.

### Delay # 1

The purpose of delay block, Delay # 1, is to implement an initial time delay into the compensation system when the distance between any of the main loudspeakers in the audio system set-up is different.

If the distance between the main loudspeakers is different, the result is that the sound from the loudspeakers arrives at different time to the listening position. The result is blurring of the 3-D effect in e.g. a stereo system.

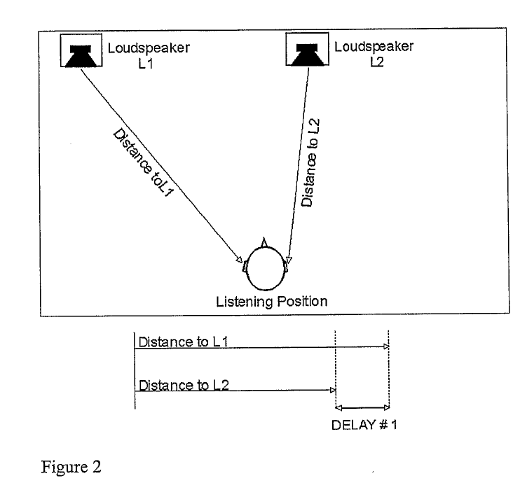

The function of the delay block Delay # 1 is illustrated in FIG. 2, which is a drawing showing the difference in time delays from two separated loudspeakers to a listening position. In FIG. 2 the loudspeakers L1 and L2 are arranged at different distances to the listening position. The distance between L1 is longer than L2. The result is that it may be necessary to add an initial delay to L2 in order to have the direct sound from both loudspeakers arriving in the listening position at the same time. The required delay for L2 is the time delay set in the delay block Delay # 1. No initial delay is required for L1 in the example shown in FIG. 2. The function of the delay block Delay # 1 is similar to prior art.

The realisation of Delay # 1 can be a RAM-based delay line. If e.g. the distance to L1 is 3 meters and the distance to L2 is 2 meters, then the required delay of Delay # 1 must be equal to the delay given by the distance 3 meter −2 meter=1 meter. Setting the speed of sound to 345 meter/sec, then the delay of Delay # 1 must be 3.45 mSec for L2. No delay is required for L1.

### FIR#1

The purpose of filter block FIR # 1 is both to align the acoustics centre for each loudspeaker driver unit of a loudspeaker as well as for correcting the higher frequency response of the system.

Alignment of acoustic centre for each loudspeaker driver unit may be done in the time domain. The alignment may be done for the first sound for each frequency arriving in the listening position from the direct sound wave.

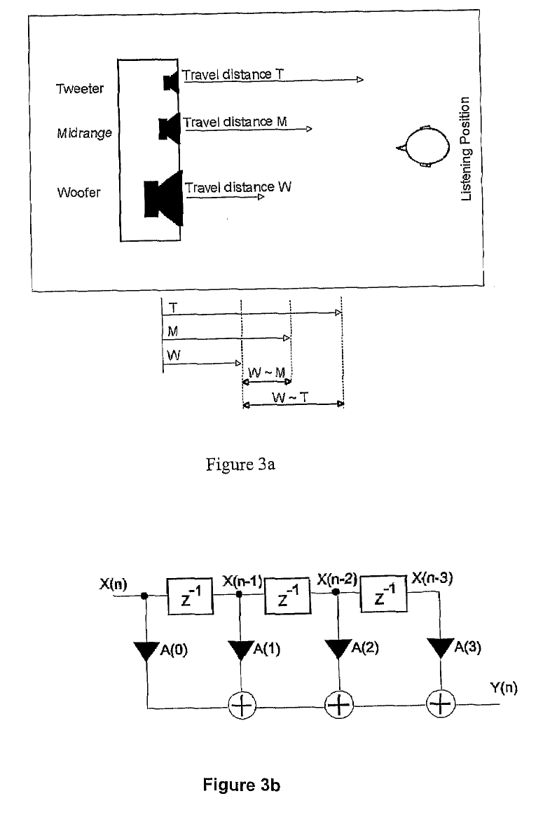

This is illustrated in FIG. 3a, which shows difference in sound travel distances between different units of a loudspeaker.

In prior art it has been found that a multi-way loudspeaker by the physical nature of the cross-over network may have problems with the impulse response as low pass filters (used for the woofer and the midrange driver) may add a time delay.

In FIG. 3a this is illustrated by the distance the sound wave has traveled through the room at a given point in time. In the example of FIG. 3a, the first sound response from tweeter T (high-frequency driver unit) arrives sooner than the sound responses of woofer W and midrange M driver units.

To obtain an improved impulse response the first sound waves from all driver units should arrive at the same time to the listening position. Thus, time delays may be added to the frequencies of the system that arrives sooner than the latest impulse step. In the example of FIG. 3a, W-OM must be added as time delay for the frequency from the midrange driver unit in order to be aligned to the step response from the woofer. Also W-T must be added as time delay for the tweeter driver unit in order to be aligned to the step response from the woofer.

An efficient solution to the filter block FIR#1 is to use a traditional FIR filter as this allows for alignment of frequencies to improve impulse response. This is illustrated in FIG. 3b, which is a diagram showing a FIR filter system, which may used when implementing the filter block FIR#1.

As opposed to prior art systems, the system of FIG. 1a may only be using a traditional FIR filter to align the loudspeaker driver units in the time domain (impulse response optimisation of loudspeaker) and correcting of high-frequency signals in frequency domain. Room compensation is not performed by use of the FIR filter of FIR#1 in the systems of FIG. 1a, FIG. 1b or FIG. 1c. An embodiment of a system of the invention may use a 144 taps FIR filter when implementing FIR # 1. At a sample frequency of 48 kHz this equals 3 mSec, which allows for time domain optimisation for acoustics centre of loudspeaker driver units corresponding to approx. 1 meter distance between fastest arriving sound step response and latest arriving sound step response. If alignment of longer distances than approx. 1 meter is required, the number of taps in FIR # 1 may be increased. For a system of the invention, it is preferred that the number of taps in the filter of FIR # 1 is reduced to a minimum to avoid prior art problems with throughput time delays in the classical FIR filter, which may result in lip sync problems in e.g. Home Cinema applications (App. 16 mSec per picture frame in NTSC and 20 mSec picture frame in PAL). The system of FIG. 1a may have 1.5 mSec throughput delay compared to a 15 mSec-25 mSec delay in a classical FIR filter approach. Lip sync problems may not occur in the system of FIG. 1a as the delay is significantly below 16 mSec.

By having the number of taps in FIR # 1 reduced to a minimum, the prior art problems with large requirements of computing power (MIPS) is reduced. Furthermore, prior art problems with rounding errors caused by the multipliers—in FIG. 3b: A(0), A(1), A(2), A(3)—in a classical FIR filter, is reduced.

Due to the length of the classical FIR filter in prior art systems, it is an advantage to use floating-point signal processors in prior art. This increases the cost of the system making it less viable for commercial applications.

A system using the principles of the present invention does not require floating-point operation to avoid any significant digital distortion of the original audio signal, but such a system can also be implemented with floating point if desired.

For the system of FIG. 1a, the filter FIR # 1 at 144 taps may also be correcting the frequency response of the system above 333 Hz. The operation is done to align the frequency response of the loudspeaker (and the equipment in general) and hereby improve the basic audible quality of the complete system. This can be done e.g. as a mirrored frequency response as described in prior art. The high frequency correction process may improve the timber matching between loudspeakers used in an audio system using the principles of the present invention.

Embodiments of the invention may also be made without the implementation of FIR#1, thereby obtaining an implementation with very low computing power requirements. A drawback here is that no time domain optimisation between loudspeaker drivers is then achieved. This is however acceptable in many low-price consumer products.

Embodiments of the invention may also be made with Multi-Rate FIR filter implementations as FIR#1 if desired. However, the decimation factor for a Multi-Rate FIR filter implementation may be less than traditional implementations as the inverse Comb function structures secure a high precision in targeting problem frequencies. Instead of the high decimation factors used in prior art solutions, a system according to the present invention may use only moderate decimation, and hereby avoid the same degree of deterioration of the original source signal compared to prior art solutions. For sub-woofer applications an approach combining the invention with a Multi-Rate FIR filter may result in a good compromise as the equalization for the loudspeaker itself can be done with high accuracy without any use of additional Shaping filters.

### Delay # 2

The purpose of delay block Delay # 2 is to implement a delay line in the systems of FIGS. 1a-1c in order to compensate for the loudspeaker position in the room.

As described in prior art, room resonances occurring from standing waves are audible in the entire room, independent of the listening position. Delay block Delay # 2 may help in optimisation of the frequency precision when modifying audible negative influence from room resonances.

Furthermore, Delay # 2 may allow for single-point room compensation against early sound reflections in time domain if desired. Compensation against the influence of early reflections is sensitive to position.

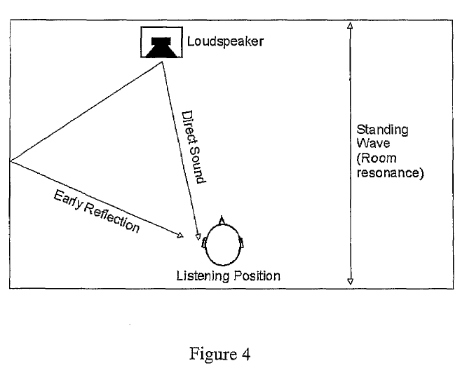

Compensation for several types of room acoustic problems may be provided using a system according to FIG. 1a, FIG. 1b or FIG. 1c. This is illustrated in FIG. 4, which shows audio signals travelling along different routes from a loudspeaker to a listening position, including direct sound, early reflections and standing waves.

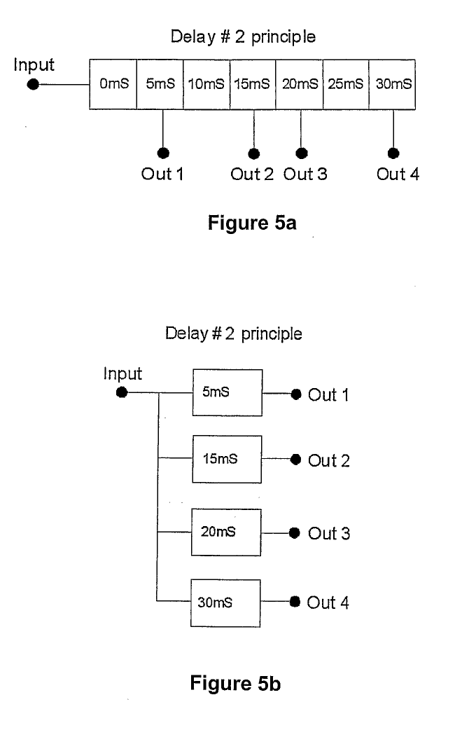

Delay # 2 may be a single input multiple output delay line allowing any delay in the parallel structure of the invention to be addressed upon demand. This is illustrated in FIG. 5a, which is a block diagram showing a RAM based delay circuit.

Delay # 2 may also or alternatively be a number of required single input single output delay lines allowing any delay in the parallel structure of the invention according to FIG. 1a or FIG. 1b to be addressed upon demand. This is illustrated in FIG. 5b, which is a block diagram showing an alternative RAM based delay circuit.

Using the examples described herein, typically settings of Delay # 2 would be as follows: 50 mSec for 20 Hz, 34.5 mSec for 29 Hz, 23.3 mSec for 43 Hz, 14.5 mSec for 69 Hz, 5 mSec for 200 Hz and 0.5 mSed for 2.000 Hz. However, it is also possible to set Delay # 2 at 0 mSec, if reduction in RAM storage is desired. The consequence is that no compensation for loudspeaker position is obtained, but the system may still operate in other aspects.

### Delay # 3

The purpose of delay block Delay # 3 is to implement a time delay when the throughput time is different for the direct signal path and the modifying signal path of the systems of FIGS. 1a-1c. Delay # 3 may be implemented using similar technique as described for Delay # 1. Delay # 3 may be redundant in most applications, and normally only used if decimation/interpolation is desired, but can also be used if FIR#1 is not used.

iComb # 1, 2, 3-X

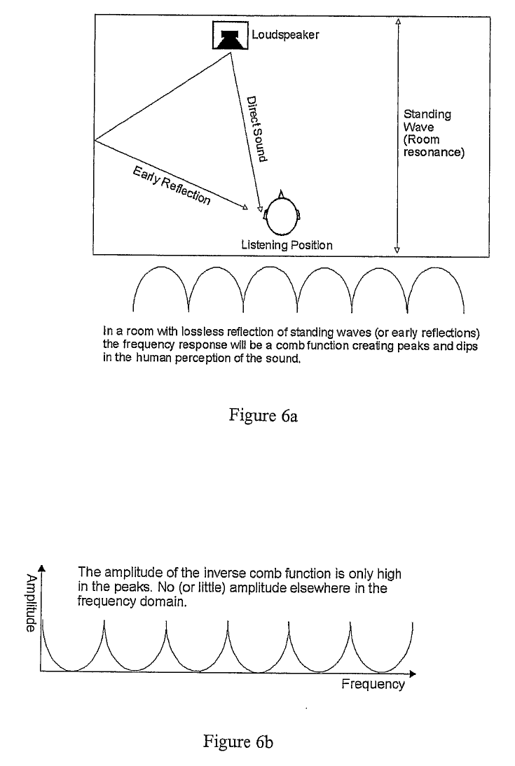

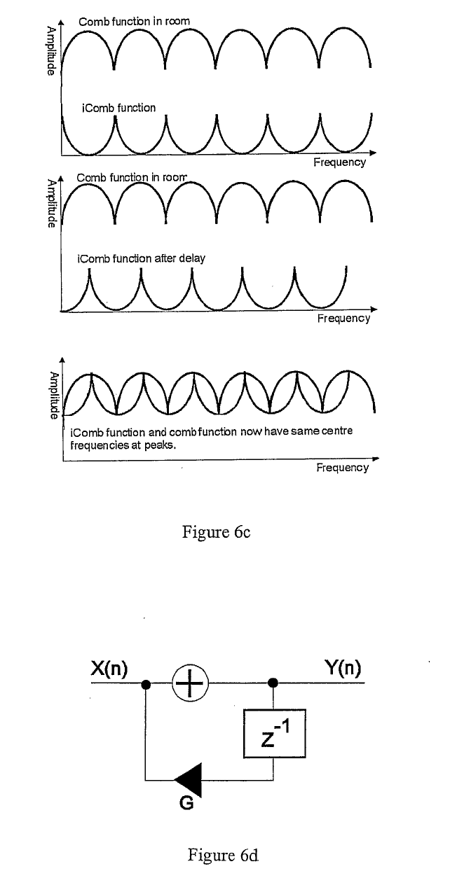

Room acoustics problems may be described by use of a comb function. This is illustrated in FIG. 6a, in which is shown the frequency response of a comb function corresponding to standing waves of an audio signal in a room with lossless reflection.

The comb function repeats itself with periodic peaks (where two sound sources are in the same phase) and periodic dips (where two sounds sources are in opposite phase). E.g. the example frequencies given herein repeat the peaks for each 20 Hz, each 29 Hz, each 43 Hz, each 69 Hz, each 200 Hz and each 2.000 Hz.

The principles of the present invention may take advantage of the knowledge of the comb function by usage of a similar periodic repeating filter, hereby reducing the required computing power significantly compared to prior art systems, in which it may be required to compensate each problem frequency individually.

In digital room compensation the task may be to eliminate or modify the audible influence of room resonances (standing waves) and if desired early reflections. Prior art systems do not always take into account psychoacoustics knowledge, and some prior art suggested solutions have been to create an inverse response of the complete audio system (including the room influence). However, this may introduce significant problems with audible peaks being introduced into the system.

A better solution is to at least partly remove audible influence from peaks, and leave narrowband dips unaltered as general psychoacoustics research may conclude that narrowband dips are not audible to human perception of sound.

A simple solution is to introduce a comb function into the system, which comb function has a repeating dip at frequencies where undesired peaks occur.

The principles of the present invention bring a solution to this problem by using an inverse comb function. By using an inverse comb function, audible amplitudes may occur only at the frequencies with room acoustic problems. See FIG. 6b, which illustrates the frequency response of an inverse comb function.

In the block function, iComb # 1˜X, the system of FIG. 1a may mimic a room acoustic problem using an equivalent computing power of only one tap per room acoustic problem. The advantage is that the frequency precision of the system may be determined by delays instead of prior arts demand of creating filter solutions requiring very large computing power (or significant decimation) to overcome each individual problem.

According to an embodiment of a system of the invention, the inverse comb function may be fed into the output signal path by the subtraction block, ADDER-2, hereby creating a difference or differential digital filter. Harmonics of the room resonance frequencies may be suppressed by the difference or differential filter approach.

The resulting signal from the structure of inverse comb functions as illustrated in FIG. 1a, FIG. 1b and FIG. 1c may have a time domain based frequency dip, which occurs at repeating room resonance frequencies.

Furthermore it is important to note that no undesired echoes occur as the amplitude of “non-problem” frequencies in the inverse comb function is very small or close to zero, and thus have only a small influence on the output from the subtraction block being fed to the output signal path.

The iComb function, used in the modifying signal parts of FIG. 1a, FIG. 1b and FIG. 1c, and the comb function used to model standing waves due to room resonances may be considered as mirrored replicas of each other. This is illustrated in FIG. 6c, which shows a comb function and an inverse comb function having maximum amplitudes at the same frequencies.

By a parallel displacement along the frequency line, both the iComb and the comb function may have maximum amplitudes at the same continuously repeating frequencies. The displacement along the frequency line may be obtained by adding a delay to the iComb function, which in FIGS. 1a and 1b is obtained by the delay block Delay#2. Hereby, the iComb functions of the modifying signal path of FIG. 1a and FIG. 1b may mimic the “problem” frequencies in the direct signal path of the system of FIG. 1a and FIG. 1b.

The same applies to FIG. 1c where the continuously repeating frequencies are realized by cascaded inverse comb filter system or structures with each structure having a single inverse Comb function.

An inverse comb function for use in the inverse comb filter blocks of FIG. 1a may be realised by using an inverse comb filter of the type shown in FIG. 6d.

The inverse comb filter, however, may generate a repeating periodic function of amplitude peaks, whereas the frequency response corresponding to the standing waves due to room acoustics problems will normally be attenuated as the harmonic frequency is increased.

To solve this problem, simple filter functions may be added to the inverse comb functions. This is shown by the BiQuad filter blocks in the modifying signal parts or paths of FIG. 1a, FIG. 1b and FIG. 1c.

### BiQuad # 1,2,3-X

Simple IIR BiQuad filters may be used to shape the harmonics of the inverse comb filter, iComb#n, hereby reducing undesired side effects from the use of the inverse comb filter functions.

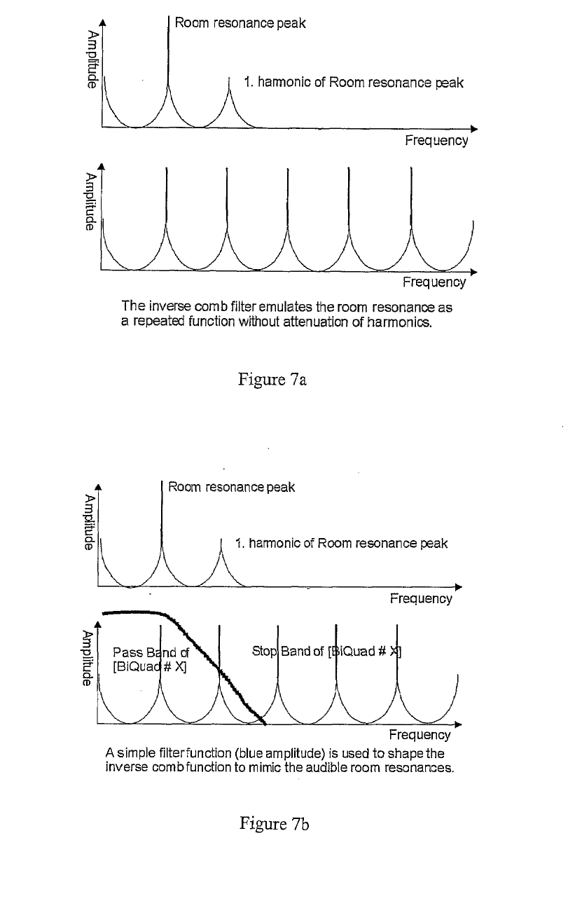

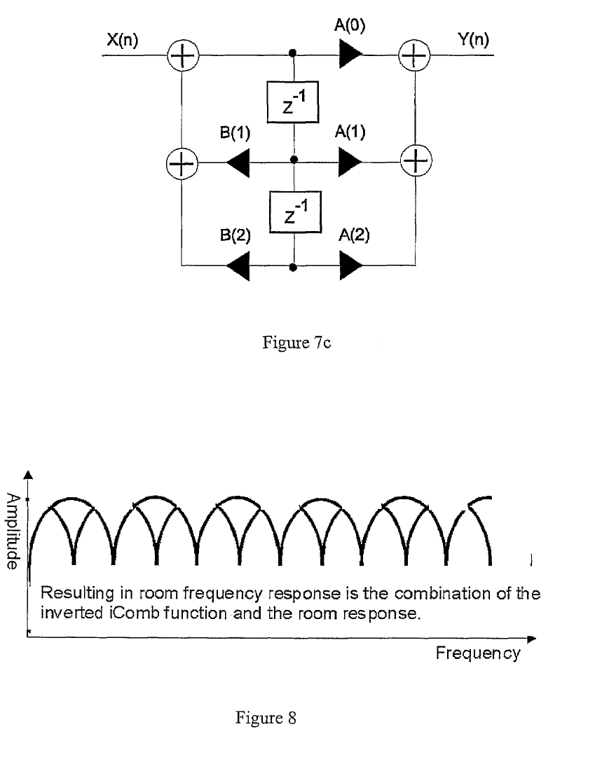

If e.g. a room resonance results in only one audible harmonic “problem” frequency, then there may not be a need for compensation for higher harmonics, as the inverse comb function alone will provide. This is illustrated in FIG. 7a, which shows amplitude attenuation for higher harmonics of a room resonance frequency response and the non-attenuated frequency response of the inverse comb filter function.

As can be seen from FIG. 7a, a filtering function may be required to attenuate the harmonic frequencies of the inverse comb filter function. This can be done by adding a BiQuad filter block to the output of an inverse comb filter block, as done in the inverse comb filter paths of FIG. 1a. The effects of adding a BiQuad filter to the output of the inverse comb filter is illustrated in FIG. 7b, which shows amplitude attenuation for higher harmonics of an inverse comb function when using a band pass filter.

It should be noticed that the BiQuad filters are not critical with regard to frequency precision, since the only purpose of the BiQuad filters is to shape the inverse comb function amplitude. If the resulting amplitude is attenuated too much, this has no or only a very small impact upon the audible perception. The same apply if the amplitude attenuation is too small; in such case the higher harmonics of the room acoustic “problem” frequency is attenuated to a small degree in a very narrow band. This is not audible to the human ear. Thus, the BiQuad filters of the inverse comb filter paths of the system of FIG. 1a are rather insensitive to tolerances in IIR filter coefficients, and there is no requirement for complex calculations of IIR filter coefficients.

In FIG. 7c is shown an example of an IIR BiQuad filter system which according to an embodiment of the principles of the present invention may be used in order to realize amplitude attenuation for higher harmonics of an inverse comb function.

It should be noted that that the filter function in the position of the BiQuad blocks, BiQuad#n, of FIG. 1a may be any digital filter function. BiQuad filters are described as they are within a preferred embodiment of the system of the invention. The system of the invention is not limited to BiQuad filters as the function can be any type of general-purpose digital filter topology suited for the purpose.

The BiQuad filters may be realized as simple 2. order band-pass functions set according the harmonics spectrum of each frequency processed by the iComb function. E.g. the 69 Hz inverse comb function signal path would set the BiQuad to a band-pass filter center frequency of 69 Hz, when the 69 Hz peak is the dominating peak in the spectrum. Practical implementations show that setting the Q factor of the band-pass filter at a default of between 0.5-2 is suitable for most applications. More advanced filter functions can be adapted as BiQuad filters if desired.

### FIR#2

If required an additional traditional FIR filter as shown in FIG. 3b may be arranged in parallel with the inverse comb filter signal paths of the system of FIG. 1a. The FIR#2 filter may be used to shape the low frequency response and remove residual problems in the time domain. The length of the FIR # 2 filter is not critical as the room acoustic problems are targeted by the inverse comb filters, iComb # 1,2,3˜X.

### ADDER-1

The ADDER-1 in FIG. 1a and FIG. 1b for adding the outputs of the BiQuad filter blocks and the FIR # 2 filter block is a traditional adder function combining the signals from the parallel signal paths. The ADDER-1 is not used in the cascaded embodiment for the invention in FIG. 1c.

### DEC and INTER

A system according to the principles of the present invention does not require decimation and the hereby following interpolation filters. The use of decimation and the hereby following interpolation filters may reduce the maximum attainable audio quality as the frequency resolution of the complete system is reduced. The number of samples in the important bass region may be reduced and this can have a negative effect upon sustain and the perception of weight in the basic tonal spectrum.

However, if it is desired to decrease the amount of memory (RAM) used in the complete system decimation and interpolation can be implemented.

Some prior art systems require decimation and interpolation as the computing power by nature of such prior art filter approaches is not feasible without decimation.

### ADDER-2

The subtraction block, ADDER-2, of FIG. 1a is designed to subtract the output resulting from the parallel structures of the modifying signal path with the output of the direct signal path. All the signals from the parallel structure of the modifying signal path may be added by ADDER-1 with the output of ADDER-1 being used for the subtraction.

The systems of FIG. 1a, FIG. 1c and FIG. 1c allow scaling the bit resolution for the parallel structures of the modifying signal path handling the room acoustics problem solutions without reducing the resolution of the main signal path of the direct audio signal. Using the principles of an embodiment of the present invention it is thus possible to scale the bit resolution in the parallel structures. It is e.g. feasible to use 24-bit resolution in the direct signal path, and use 16-bit resolution in the inverse comb filter systems or structures featuring the inverse Comb functions.

By use of the subtraction block, ADDER-2, the iComb functions, as illustrated in FIG. 6c, from the modifying signal path of the system of FIG. 1a are subtracted from the output of the direct signal path, and the result is a filter that attenuates peaks in the room acoustic frequency response hereby improving the audible performance. The advantage is that room acoustic harmonics are also eliminated without increasing the computing power required and that no overflow occurs when combining the output signal of the modifying signal path with the output of the direct signal path. The subtraction process is illustrated in FIG. 8.

### Shaping

The equaliser block, Shaping, of the functional schematic in FIG. 1a is a traditional equaliser function realised by BiQuad IIR filters, see FIG. 7c.

The purpose of the Shaping block is to enable the user of the invention to change the tonal balance of the audio system to any desired requirement. This can be done without audible problems as the compensated system of FIG. 1a is a minimum-phase system, and negative room acoustics problems (standing waves and if desired room reflections) are reduced.

The Shaping filters may typically be realized as peaking filters, shelving filters, band-pass filters, high-pass filters and low-pass filters upon demand. The Shaping filters are similar in function to any other classical equalizer function. The Shaping filter may be made redundant in whole or partially by the FIR#1 filter, if desired.

Those skilled in the art will appreciate that the invention is not limited by what has been particularly shown and described herein as numerous modifications and variations may be made to the preferred embodiment without departing from the spirit and scope of the invention.

1. An audio system comprising:
an audio signal source for outputting an electrical signal representing an acoustic audio signal,
a sound source for reproducing an acoustic audio signal, said sound source having an electrical signal input and being operative to generate an acoustic audio output in response to a signal supplied to the electrical signal input, and
one or more inverse comb filter systems arranged between the audio signal source and the signal input of the sound source for delivering a modified signal to the electrical signal input of the sound source, wherein each inverse comb filter system comprises
a subtraction circuit for delivering a modified inverse comb filter system output signal,
a direct signal part between the input of the inverse comb filter system and the subtraction circuit, and
a modifying signal part between the input of the inverse comb filter system and the subtraction circuit, said modifying signal part comprising one or more inverse comb filter signal paths, each said inverse comb filter signal path having circuitry for performing an inverse comb filter function, and said subtraction circuit being designed for performing a subtraction of the signals supplied via the direct signal part and the modifying signal part to thereby obtain the modified inverse comb filter system output signal.

2-4. (canceled)

5. An audio system according to claim 1, said system comprising at least a first and a second of said inverse comb filter systems arranged in series.

6. (canceled)

7. An audio system according to claim 1, wherein each modifying signal part of said inverse comb filter systems comprises one and only one inverse comb filter signal path.

8. (canceled)

9. An audio system according to claim 1, wherein the circuitry for performing an inverse comb filter function comprises at least one feed-back IIR circuit architecture.

10. An audio system according to claim 1, wherein the inverse comb filter function of an inverse comb filter signal path is selected so as compensate for or modifying the effects of standing waves corresponding to a characteristic longitudinal dimension of the surroundings of the sound source.

11-13. (canceled)

14. An audio system according to claim 1, wherein the modifying signal part of each of said one or more inverse comb filter systems has delay circuitry for providing a time delay to each or at least part of said one or more inverse comb filter signal paths.

15. (canceled)

16. An audio system according to claim 14, wherein the time delay and the inverse comb filter function of an inverse comb filter signal path are selected so as to compensate for or modify the effects of standing waves corresponding to the same characteristic longitudinal dimension of the surroundings of the sound source.

17. (canceled)

18. An audio system according to claim 16, wherein the time delay and the inverse comb filter function of the inverse comb filter signal path are selected so that the frequency response of the output signal of the inverse comb filter signal path has magnitude peaks at substantially the same frequencies as the magnitude peaks of the frequency response of the standing waves corresponding to the selected characteristic longitudinal dimension of the surroundings of the sound source.

19. An audio system according to claim 1, wherein an inverse comb filter signal path further has circuitry for performing an amplitude shaping of the output of the inverse comb filter circuitry of said inverse comb filter signal path, thereby providing an amplitude shaped output of the inverse comb filter signal path.

20-23. (canceled)

24. A method of modifying an audio signal using an audio system, said audio system comprising: an audio signal source for outputting an electrical signal representing an acoustic audio signal; a sound source for reproducing an acoustic audio signal, said sound source having an electrical signal input and being operative to generate an acoustic audio output in response to a signal supplied to the electrical signal input; and one or more inverse comb filter systems arranged between the audio signal source and the signal input of the sound source for delivering a modified signal to the electrical signal input of the sound source; wherein said method comprises:
generating for each of the inverse comb filter systems a direct audio signal based at least partly on the output of the audio signal source,
generating for each of the inverse comb filter systems a modified audio signal based at least partly on the output of the audio signal source, and
for each of the inverse comb filter systems performing a subtraction of the corresponding generated direct audio signal and the corresponding generated modified audio signal to thereby obtain a corresponding modified inverse comb filter system output,
wherein the generation of the modified audio signal(s) is/are accomplished by means of one or more corresponding inverse comb filter functions.

25-31. (canceled)

32. A method according to claim 24, wherein an inverse comb filter function is performed by a circuitry comprising at least one feed-back IIR circuit architecture.

33. A method according to claim 24, wherein an inverse comb filter function being used for the generation of a modified audio signal is selected so as compensate for or modifying the effects of standing waves corresponding to a characteristic longitudinal dimension of the surroundings of the sound source.

34-36. (canceled)

37. A method according to claim 24, wherein the generation of a modified audio signal includes providing a time delay to each or at least part of the corresponding inverse comb filter functions.

38. A method according to claim 37, wherein the time delay of an inverse comb filter function is selected so as compensate for or modify the effects of standing waves corresponding to a characteristic longitudinal dimension of the surroundings of the sound source.

39. A method according to claim 38, wherein, for a corresponding set of time delay and inverse comb filter function, the time delay and the inverse comb filter function are selected so as to compensate for or modify the effects of standing waves corresponding to the same selected characteristic longitudinal dimension of the surroundings of the sound source.

40. A method according to claim 39, wherein, for the corresponding set of time delay and inverse comb filter function, the time delay and the inverse comb filter function are selected so that the frequency response of the output signal of the inverse comb filter function has magnitude peaks at different frequencies than the magnitude notches of the frequency response of the standing waves corresponding to the selected characteristic longitudinal dimension of the surroundings of the sound source.

41. A method according to claim 39, wherein, for the corresponding set of time delay and inverse comb filter function, the time delay and the inverse comb filter function are selected so that the frequency response of the output signal of the inverse comb filter function has magnitude peaks at substantially the same frequencies as the magnitude peaks of the frequency response of the standing waves corresponding to the selected characteristic longitudinal dimension of the surroundings of the sound source.

42. A method according to claim 24, wherein the generation of a modified audio signal further includes performing an amplitude shaping of the output of each or at least part of the inverse comb filter functions.

43. A method according to claim 24, wherein the generation of a modified audio signal is further accomplished by a FIR filtering function being performed in parallel with the one or more inverse comb filter functions.

44-46. (canceled)

47. A filter system for modifying an electrical signal, said filter system comprising
an input for receiving an electrical signal to be modified,
a subtraction circuit for delivering a modified output signal,
a direct signal part between the input and the subtraction circuit, and
a modifying signal part between the input and the subtraction circuit, said modifying signal part comprising one or more inverse comb filter signal paths, each said inverse comb filter signal path having circuitry for performing an inverse comb filter function, and said subtraction circuit being designed for performing a subtraction of the signals supplied via the direct signal part and the modifying signal part to thereby obtain the modified output signal.

48. A filter system according to claim 47, wherein the signal supplied to subtraction circuit by the modifying signal part has been filtered by use of the one or more inverse comb filter functions.

49-52. (canceled)

53. A filter system according to claim 47, wherein the circuitry for performing an inverse comb filter function comprises at least one feed-back IIR circuit architecture.

54. A filter system according to claim 47, wherein the modifying signal part has delay circuitry for providing a time delay to each or at least part of the inverse comb filter signal paths.

55. A filter system according to claim 47, wherein an inverse comb filter signal path further has circuitry or means for performing an amplitude shaping of the output of the inverse comb filter circuitry or means of said inverse comb filter signal path, thereby providing an amplitude shaped output of the inverse comb filter signal path.

56. A filter system according to claim 55, wherein said amplitude shaping circuitry or means comprises HR filtering circuitry.

57-59. (canceled)
